(19) United States
(12) Patent Application Publication
(10) Pub. No.: US 2009/0203570 A1
(43) Pub. Date: Aug. 13, 2009

(54) Fabric Conditioner Compositions

(76) Inventors: Vidur Behal, Mumbai (IN); Kaushik Narotam Divecha, Mumbai (IN); Kandala Srinivasa Rao, Trumbull, CT (US); Vivek Sirohi, Mumbai (IN)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/223,725

(22) PCT Filed: Jan. 31, 2007
(86) PCT No.: PCT/EP2007/000899

§ 371 Date: Nov. 12, 2008

(30) Foreign Application Priority Data
Feb. 10, 2006 (IN) 0189/MUM/2006

(51) Int. Cl. C11D 3/26

(52) U.S. Cl. 510/522

(57) ABSTRACT

A fabric conditioner composition comprising: (g) 0.1-20% by weight cationic fabric conditioner active; (h) 0.1-5% by weight anion quencher selected from mono-long chain quaternary ammonium compound of the general formula R(R1)3N+X- or alkyl benzyl quaternary ammonium compound of a general formula R2R3(R4)2N+X-; (i) 0.1-10% by weight organic acid having from 1 to 8 carbon atoms; where R is selected from C8-C22 alkyl or alkenyl group, R1 is selected from C1-C3 alkyl group, R2 is selected from C6-C18 alkyl or alkenyl group, R3 is benzyl group, R4 is selected from C1-C3 alkyl group, and X is an anion selected from chloride, bromide, iodide, nitrate, sulfate, methyl sulfate, ethyl sulfate, acetate and phosphate.

### TECHNICAL FIELD

This invention relates to a fabric conditioner composition. The invention particularly relates to a liquid fabric conditioner composition suitable for use during first rinse.

### BACKGROUND AND PRIOR ART

Fabric conditioners are well known in the art. Conventionally, during regular washing process, fabrics are rinsed 3 to 4 times and fabric conditioner is added in the last rinsing cycle. Rinsing consumes a lot of fresh water which is globally becoming a scarce and premium resource in view of limited availability and increasing usage.

Rinsing is a tedious process particularly in hand washing. Fabric conditioners that can be added during the first rinse cycle not only deliver benefits of regular fabric softening or conditioning but also help in eliminating the subsequent rinses and consequently reduce time of washing and consumption of water and energy. There is an unmet consumer need for fabric conditioners that eliminate repeat rinsing and avoid subsequent rinses by using the conditioner in the first rinse itself. This will offer speed, economy and convenience besides being environment friendly.

U.S. Pat. No. 6,110,886 describes solid cast fabric softening composition comprising di-hydrogenated tallow di-methyl ammonium chloride, citric acid and silicone emulsion antifoam. It does not describe specific mixtures of cationic fabric conditioner active and anion quencher.

EP1149891 discloses aqueous laundry detergent composition comprising a blend of quaternary ammonium fabric softener actives 1-50% by weight of at least one anionic scavenger and 50-99% by weight of at least on triglyceride based ester quat. Use of organic acid is not described.

Fabric softening composition comprising cationic fabric conditioning active and acids including citric acid are described in DE3312328 and EP0404471. US20030228992 describes a granular laundry detergent composition comprising a silicone antifoam in addition. However, they do not describe particular combinations of cationic active and anion quencher.

There is no prior art that describes fabric conditioner composition comprising fabric conditioner active, anion quencher and organic acid. None of the prior art cited above is directed towards eliminating the need for repeat rinses or avoiding subsequent rinses by using fabric conditioner during the first rinse itself.

The present inventors have surprisingly found that by using a combination of cationic active along with an anion quencher and an organic acid, it has been possible to formulate a fabric conditioner composition that can be added during the first rinse itself to provide improved fabric softening and enable retention of fragrance on the fabric.

### SUMMARY OF THE INVENTION

According to the present invention there is provided a fabric conditioner composition comprising
(a) 0.1-20% by weight cationic fabric conditioner active;
(b) 0.1-5% by weight anion quencher selected from mono-long chain quaternary ammonium compound of the general formula R(R¹)₃N⁺X⁻ or alkyl benzyl quaternary ammonium compound of a general formula R²R³(R⁴)₂N⁺X⁻;
(c) 0.1-10% by weight organic acid having from 1 to 8 carbon atoms;
where R is selected from C₈-C₂₂ alkyl or alkenyl group, R¹ is selected from C₁-C₃ alkyl group, R² is selected from C₆-C₁₈ alkyl or alkenyl group, R³ is benzyl group, R⁴ is selected from C₁-C₃ alkyl group, and X is an anion selected from chloride, bromide, iodide, nitrate, sulfate, methyl sulfate, ethyl sulfate, acetate and phosphate.

The invention provides a fabric conditioner composition that gives improved fabric softening performance when added in the first rinse cycle itself, eliminating the need for repeat rinsing and avoiding subsequent rinsing, thus offering speed, economy and convenience. Thus the composition economises the use of water, energy and effort and also reduces the quantity of discharge and the pH of the discharge is below 8 which makes it environment-friendly.

The fabric conditioner composition of the present invention can be used in machine wash as well as hand wash.

The fabric conditioner composition of the present invention provides fabric softening even when the initial pH of the rinse liquor is above 8.

Fabric conditioner compositions of the present invention give better fragrance retention on the fabric.

One of the preferred cationic fabric conditioner active has a general formula R⁵R⁶(R¹)₂N⁺X⁻,
where R⁵ and R⁶ are each different or identical compounds selected from C₈-C₂₄ alkyl or alkenyl group, R⁷ is selected from C₁-C₃ alkyl group and X is an anion selected from chloride, bromide, iodide, nitrate, sulfate, methyl sulfate, ethyl sulfate, acetate and phosphate.

Another preferred active has a general formula (R⁸COO(CH2)ₘ)₂R⁹R¹⁰N⁺X⁻,
where R⁸ is selected from C₈-C₂₄ alkyl or alkenyl group, m is an integer from 1 to 8, R⁹ and R¹⁰ are selected from C₁-C₃ alkyl group or —(CH₂)ₚOH, where p is an integer from 1 to 10 and X is anion selected from chloride, bromide, iodide, nitrate, sulfate, methyl sulfate, ethyl sulfate, acetate and phosphate.

It is preferred that anion quencher is either said alkyl benzyl quaternary ammonium compound or said mono-long chain quaternary ammonium compound.

It is preferred that the fabric conditioner composition optionally comprises 0.01-3% by weight an antifoam agent.

### DETAILED DESCRIPTION OF THE INVENTION

The present invention is directed to a fabric conditioner composition that comprises cationic fabric conditioner active, anion quencher and C₁-C₈ organic acid. The composition of the present invention is typically a liquid with a viscosity between 20-200 cP at a shear rate of 106 s⁻¹.

### Fabric Conditioner Active

The composition of the present invention comprises, by weight, preferably 0.1-20%, more preferably 2-18%, most preferably 3-15% of fabric conditioner active.

Any conventional fabric conditioner active can be chosen to formulate the composition according to the present invention.

One of the preferred cationic fabric conditioner active has a general formula R⁵R⁶(R⁷)₂N⁺X⁻,

where R⁵ and R⁶ are each different or identical groups selected from C₈-C₂₄ alkyl or alkenyl group, R⁷ is selected from C₁-C₃ alkyl group and X is an anion selected from chloride, bromide, iodide, nitrate, sulfate, methyl sulfate, ethyl sulfate, acetate and phosphate.

It is particularly preferred that the R⁵ and R⁶ groups are selected from alkyl or alkenyl groups derived from tallow or vegetable oils. It is further preferred that the active has R⁵ and R⁶ groups derived from preferably partially hydrogenated, or more preferably fully hydrogenated tallow or vegetable oil source. In literature, the term hardened is sometimes used synonymously with hydrogenated, and such hardened or partially hardened active is preferred according to the present invention.

R⁵ and R⁶ groups of the active are selected from preferably C₈-C₂₄ alkyl or alkenyl group, more preferably from C₁₄-C₂₂ alkyl or alkenyl group, and most preferably form C₁₆-C₁₈ alkyl or alkenyl group. Preferably, R⁵ and R⁶ groups of the active are selected from C₈-C₂₄ alkyl group.

Preferred anion X of the active is chloride. One of the most preferred of the active of this category is di-hydrogenated tallow di-methyl ammonium chloride.

Another preferred active is diester quaternary compound, commonly known as diester quat, and has a general formula (R⁸COO(CH₂)ₘ)₂R⁹R¹⁰N⁺X⁻,
where R⁸ is selected from C₈-C₂₄ alkyl or alkenyl group, m is an integer from 1 to 8, R⁹ and R¹⁰ are selected from C₁-C₃ alkyl group or —(CH₂)ₚOH, where p is an integer from 1 to 10 and X is anion selected from chloride, bromide, iodide, nitrate, sulfate, methyl sulfate, ethyl sulfate, acetate and phosphate.

It is preferred that the active has R⁸ group is selected from preferably C₈-C₂₄ alkyl or alkenyl group, more preferably from C₁₄-C₂₂ alkyl or alkenyl group, and most preferably form C₁₆-C₁₈ alkyl or alkenyl group. Preferably, R⁵ and R⁶ groups of the active are selected from C₈-C₂₄ alkyl group.

It is further preferred that R⁸ group of the active is derived from preferably partially hydrogenated, or more preferably fully hydrogenated tallow or vegetable oil source. In literature, the term hardened is sometimes used synonymously with hydrogenated, and such hardened or partially hardened actives are preferred according to the present invention.

Preferred diester quat active has a value of m preferably from 1 to 8, more preferably from 1 to 5 and most preferably from 1 to 3. R⁹ and R¹⁰ groups are selected from preferably C₁-C₃ alkyl group, more preferably from C₁-C₂ alkyl group and most preferably are methyl groups.

The anion X of the preferred diester quat active according to the present invention is selected from chloride, bromide, iodide, nitrate, sulfate, methyl sulfate, ethyl sulfate, acetate and phosphate. Anion X refers to half an anion for bivalent anions and to one third of anion for trivalent anions. Chloride anion is particularly preferred.

Some non-limiting examples of suitable actives according to the present invention include Arquad 2HT (Akzo Nobel) and 1821 SE (FXG, China), partially hydrogenated tallow DEEDMAC (diethyl diethanolamine dimethyl ammonium chloride, 2,3-diacyloxypropane trimethyl ammonium chloride, hardened triethanolamine ester quaternary ammonium sulfate and partially hardened triethanolamine ester quaternary ammonium sulfate.

### Anion Quencher

The term anion quencher, as used in the present invention, refers to a cationic compound that forms complex with anionic surfactants and preferably has equivalent weight less than the equivalent weight of active.

Fabric conditioner composition of the present invention preferably comprises 0.1-5% by weight anion quencher selected from mono-long chain quaternary ammonium compound of the general formula R(R¹)₃N⁺X⁻ or alkyl benzyl quaternary ammonium compound of a general formula R²R³(R⁴)₂N⁺X⁻;

where R is selected from C₈-C₂₂ alkyl or alkenyl group, R¹ is selected from C₁-C₃ alkyl group, R² is selected from C₆-C₁₈ alkyl or alkenyl group, R³ is benzyl group, R⁴ is selected from C₁-C₃ alkyl group, and X is an anion selected from chloride, bromide, iodide, nitrate, sulfate, methyl sulfate, ethyl sulfate, acetate and phosphate.

It is preferred that anion quencher of the present invention is either the alkyl benzyl quaternary ammonium compound or the mono-long chain quaternary ammonium compound.

Preferred alkyl benzyl quaternary ammonium compound of the present invention has R² group preferably selected from C₆-C₁₈ alkyl or alkenyl group, more preferably selected from C₈-C₁₆ alkyl or alkenyl group, and most preferably from C₁₂-C₁₄ alkyl or alkenyl group. It is preferred that R² group is selected from C₆-C₁₈ alkyl group.

Alkyl benzyl dimethyl ammonium compounds are particularly preferred as anion quencher.

One of the examples of preferred alkyl benzyl quaternary ammonium compound according to the present invention is benzalkonium chloride (Galaxy Surfactants, India) which is a mixture of alkyl benzyl dimethyl ammonium chlorides with R² group being a mixture of C₁₂ and C₁₄ alkyl groups.

Preferred mono-long chain quaternary ammonium compound of the present invention is one where R group is selected preferably from C₈-C₂₂ alkyl or alkenyl group and more preferably from C₁₂-C₁₈ alkyl or alkenyl group. It is preferred that R² group is selected from C₈-C₂₂ alkyl group.

Particularly preferred mono-long chain quaternary ammonium compound of the present invention is one where R¹ group is methyl.

Some non-limiting examples of mono-long chain quaternary ammonium compound according to the present invention include:

Cetyl trimethyl ammonium chloride
Stearyl trimethyl ammonium chloride
Behenyl trimethyl ammonium chloride
Organic Acid Having from 1 to 8 Carbon Atoms

Composition according to the present invention comprises preferably 0.1-10% by weight, more preferably 0.2-8, most preferably 3-6%, by weight organic acid having from 1 to 8 carbon atoms

It is highly desirable to use low equivalent weight carboxylic acids, e.g. those having an equivalent weight of from about 45 to about 200, preferably from about 50 to about 135, more preferably from about 60 to about 100. Suitably carboxylic acids, in particular organic acids with 1 to 6 carbon atoms are described in EP0404471.

Preferably the organic acid is selected from the group comprising acetic acid, glycolic acid, propionic acid, adipic acid, benzoic acid, 4-hydroxy benzoic acid, phenylacetic acid, citric acid, salicylic acid, tartaric acid, fumaric acid, succinic acid, maleic acid, oxalic acid, oxalacetic acid, tricarballylic acid, 1,2,3,4,-butanetetracarboxylic acid, dihydrofumaric acid, nitrilotriacetic acid, and mixtures thereof. Citric acid is particularly preferred.

### Antifoam Agent

Fabric conditioner composition according to the present invention comprises from about 0.01% to about 3%, preferably from about 0.01% to about 2%, more preferably from about 0.05% to about 1.5% by weight of the composition, of an antifoam agent.

Silicone based antifoam agents are particularly preferred. The silicone antifoam can be alkylated polysiloxane material of several types, either singly or in combination with various solid materials such as silica aerogels and xerogels and hydrophobic silicas of various types. In industrial practice, the term “silicone” has become a generic term which encompasses a variety of relatively high molecular weight polymers containing siloxane units and hydrocarbyl groups of various types. In general terms, silicone suitable as a component of antifoam agent is also termed as siloxane. The polydimethylsiloxane having a molecular weight within the range of from about 200 to about 200,000, and higher, is useful component of antifoam agent.

Some non-limiting examples of preferred commercially available antifoam agents according to the present invention include SE 47 (Wacker), Silicone 200 Fluids® (Dow Corning), DC-2210 (Dow Corning). Other preferred antifoam materials are described in U.S. Pat. No. 4,652,392, Baginski et al., issued on Mar. 24, 1987, which is herein incorporated by reference in its entirety.

### Optional Ingredients

### Water

According to an aspect of the present invention, the fabric conditioner composition comprises preferably about 50 to 99% water by weight, more preferably of about 75-98% water by weight.

### Antiredeposition Agents

Fabric conditioner composition according to the present invention comprises of antiredeposition agent. Choice of antiredeposition agent is usually dictated by cost, availability and compatibility with the rest of the composition. Preferred antiredeposition agents according to the present invention include sodium carboxy methyl cellulose (SCMC), hydroxylethyl cellulose, hydroxyl propyl methyl cellulose and nonionic ethoxylated alcohol with between 20-30 ethylene oxide groups. It is particularly preferred that the composition does not comprise of SCMC as it is less compatible with the composition according to the present invention.

### Fragrance

The composition of the invention typically comprises fragrance, preferably present in an amount from 0 to 10% by weight, more preferably 0.05 to 5% by weight, most preferably 0.5 to 4.0% by weight, based on the total weight of the composition.

The composition of the invention allows better fragrance retention on fabrics post rinse and post drying.

### Co-Softener

Non-cationic Co-softeners may be used together with the cationic softening agent. When employed, they are typically present at from 0.1 to 20% and particularly at from 0.5 to 10%, based on the total weight of the composition. Preferred co-softeners include fatty esters, fatty N-oxides and ethoxylated alcohols with 1-16 ethylene oxide groups.

Fatty esters that may be employed include fatty monoesters, such as glycerol monostearate, fatty sugar esters, such as those disclosed in WO 01/46361.

### Other Ingredients

The composition of the invention may contain one or more other ingredients. Such ingredients include preservatives (e.g. bactericides), pH buffering agents, perfume carriers, fluorescers, colourants, hydrotropes, soil-release agents, polyelectrolytes, enzymes, optical brightening agents, anti-shrinking agents, anti-wrinkle agents, anti-spotting agents, anti-oxidants, sunscreens, anti-corrosion agents, drape imparting agents, anti-static agents, ironing aids, dyes, antibacterials, musty odour preventing compounds, perfume encapsulates, cotton seed oil, tea tree oil and Aloe Vera. Another optional ingredient is an opacifier or a pearlescer such as Aquasol OP30X® (Rohm and Haas) and Puricolor White®.

### Process for Preparation

Composition of the present invention can be prepared using any conventional liquid mixing equipment. The process of manufacture involves addition of all the ingredients of the composition and mixing. The processing may be carried out at temperature between 10-90° C., more preferably in the range 30-80° C. It is preferable that a premix comprising all the ingredients except active and fragrance is prepared separately and the active heated to 70-90° C. is added to the premix followed by cooling to 30-60° C., and subsequent optional addition of fragrance.

### EXAMPLES

Fabric conditioner composition of the present invention will now be exemplified by a few non-limiting examples. Following ingredients were used in the examples

TABLE 1
List of ingredients used in examples

| INGREDIENT | TRADE NAME | SOURCE |
|---|---|---|
| Di-hydrogenated | Arquad 2HT | Akzo Nobel, |
| tallow dimethyl | | Singapore |
| ammonium chloride | | |
| Benzalkonium | BKC | Galaxy |
| chloride | | Surfactants, |
| | | India |
| Cetyl trimethyl | CTAC | KCL, Korea |
| ammonium chloride | | |
| Citric Acid | — | Sanxi Prosperous |
| | | Chemical |
| | | Industries, China |
| Antifoam agent | SE-47 | Wacker |
| Fragrance | — | IFF |

All the compositions in the examples described in following tables were prepared according to the following process. Demineralized (DM) water was heated to about 60° C. and all ingredients except the fabric conditioning active and fragrance were added to the DM water at about 60° C. and a premix was prepared. In a separate vessel, conditioner active was heated to about 80° C., and was slowly added to the premix under stirring and the stirring was continued for 20 minutes. In those examples where fragrance was present, it was added after cooling the final mix to about 45° C.

### Example 1 and Comparative Examples A, B and C

Composition according to the invention and comparative examples are presented in Table 2. The compositions were tested for determining the effect on fabric softness and pH when added during the first rinse. The methodology used for evaluation is presented below.

### Methodology of Performance Evaluation:

Fabrics were washed in washing machine using at a cloth to liquor ratio of 10 using commercially available powder detergent (Surf Excel, India) dosed at 5 g/L, Fabric conditioner composition described in Table 1 was evaluated by adding it during the first rinse cycle at a dosage of 2.5 g/L. Fabrics were kept for 10 minutes in the rinse solution, followed by squeezing and line drying.

The effect of the composition on fabric softness was evaluated using a trained panel of 10 persons who scored based on a scale of 0-10 (scores of 0 and 10 indicating the harshest and the softest feel, respectively). A softness score above 2.3 is satisfactory whilst a score below 2.3 is not acceptable. pH of the final rinse liquor is measured by using a pH meter. Final liquor pH of less than 8 is satisfactory whilst pH above B is not satisfactory from consumer hand-feel and environmental point of view. Initial pH was greater than 8 for all examples.

TABLE 2

| Ingredient | | | | |
|---|---|---|---|---|
| (% by weight) | Ex 1 | Ex A | Ex B | Ex C |
| Arquad 2HT | 7.5 | 7.5 | 7.5 | — |
| BKC | 3 | 3 | — | 3 |
| Citric Acid | 5 | — | 5 | 5 |
| Water and minor | To 100 | To 100 | To 100 | To 100 |
| ingredients | | | | |
| Fabric Softness | 3.2 | 2.6 | 2.1 | 1.7 |
| pH | 6.9 | 8.9 | 6.9 | 6.9 |

It is clear from the above result that both fabric softness and pH of Ex 1 are within acceptable range. In case of comparative examples A, B and C, the fabric softness score is less than the Fabric softness score of Example Ex 1. pH of the final rinse for Comparative Example Ex A is higher than acceptable value of 8, whilst softness scores of comparative Examples Ex B and Ex C are too low.

### Example 2 and Comparative Examples A′, B′ and C′

Composition according to the invention and comparative examples are presented in Table 3. The compositions were tested for determining the effect on fabric softness, pH and fragrance retention post wash and drying when added during the first rinse. The methodology used for evaluation is presented below.

### Methodology of Evaluating Fragrance Retention:

The wash and evaluation protocol was similar to that described above. The effect of the composition on fragrance retention was evaluated using a trained panel of 10 persons who scored based on a scale of fragrance retention: 0-4 (scores of 0 and 4 indicating the lowest and the highest, respectively). A fragrance retention score above 0.8 is satisfactory.

TABLE 3

| Ingredient | | | | |
|---|---|---|---|---|
| (% by weight) | Ex 2 | Ex A′ | Ex B′ | Ex C′ |
| Arquad 2HT | 7.5 | 7.5 | 7.5 | — |
| BKC | 3 | 3 | — | 3 |
| Citric Acid | 5 | — | 5 | 5 |
| Fragrance | 2.7 | 2.7 | 2.7 | 2.7 |
| Water and minor | To 100 | To 100 | To 100 | To 100 |
| ingredients | | | | |
| Fabric Softness | 3.2 | 2.6 | 2.1 | 1.7 |
| pH | 6.9 | 8.9 | 6.9 | 6.9 |
| Fragrance Retention | 1 | 1 | 0.66 | 0.53 |

It is clear from table 3 that composition of the present example, Ex 2 gives acceptable performance in all the three parameters, namely fabric softness, pH and fragrance retention whilst performance of comparative examples is not satisfactory for at least one of the parameters evaluated.

### Example 3-6

Additional examples of composition that are within the scope of the present invention are given below in table 4.

TABLE 4

| Ingredient | | | | |
|---|---|---|---|---|
| (% by weight) | Ex 3 | Ex 4 | Ex 5 | Ex 6 |
| Arquad 2HT | 14 | 14 | 14 | 7.5 |
| C16TAC | 1 | — | 1 | — |
| BKC | — | 1 | — | 1 |
| Citric Acid | 5 | 5 | 5 | 5 |
| Antifoam | — | — | 1 | 1 |
| Fragrance | 2.7 | 2.7 | 2.7 | 2.7 |
| Water and minor | To 100 | To 100 | To 100 | To 100 |
| ingredients | | | | |
| Fabric Softness | 3.2 | 2.7 | 3.4 | 2.7 |
| pH | 6.7 | 6.8 | 6.9 | 7 |
| Fragrance Retention | 1.2 | 1 | 1.2 | 1 |

From table 4, it is clear that the performance of composition Example 3, 4, 5 and 6 is satisfactory in terms of all the parameters, namely fabric softness, pH and fragrance retention. Corresponding comparative compositions give unsatisfactory performance in terms of at least one of the parameters.

1. A fabric conditioner composition comprising:
(a) 0.1-20% by weight cationic fabric conditioner active;
(b) 0.1-5% by weight anion quencher selected from mono-long chain quaternary ammonium compound of the general formula R(R¹)₃N⁺X⁻ or alkyl benzyl quaternary ammonium compound of a general formula R²R³(R⁴)₂N⁺X⁻;
(c) 0.1-10% by weight organic acid having from 1 to 8 carbon atoms;
where R is selected from C₈-C₂₂ alkyl or alkenyl group, R¹ is selected from C₁-C₃ alkyl group, R² is selected from C₆-C₁₈ alkyl or alkenyl group, R³ is benzyl group, R⁴ is selected from C₁-C₃ alkyl group, and X is an anion selected from chloride, bromide, iodide, nitrate, sulfate, methyl sulfate, ethyl sulfate, acetate and phosphate.

2. A fabric conditioner composition as claimed in claim 1, wherein said active has a general formula R⁵R⁶(R⁷)₂N⁺X⁻,
where R⁵ and R⁶ are each different or identical groups selected from C₈-C₂₄ alkyl or alkenyl group, R⁷ is selected from C₁-C₃ alkyl group and X is an anion selected from chloride, bromide, iodide, nitrate, sulfate, methyl sulfate, ethyl sulfate, acetate and phosphate.

3. A fabric conditioner composition as claimed in claim 1, wherein said fabric conditioner active is di-hydrogenated tallow dimethyl ammonium compound

4. A fabric conditioner composition as claimed in claim 1, wherein said active has a general formula (R⁸COO(CH₂)ₘ)₂R⁹R¹⁰N⁺X⁻,
where R⁸ is selected from C₈-C₂₄ alkyl or alkenyl group, m is an integer from 1 to 8, R⁹ and R¹⁰ are selected from C₁-C₃ alkyl group or —(CH₂)ₚOH, where p is an integer from 1 to 10 and X is anion selected from chloride, bromide, iodide, nitrate, sulfate, methyl sulfate, ethyl sulfate, acetate and phosphate.

5. A fabric conditioner composition as claimed in claim 1, wherein anion quencher is said alkyl benzyl quaternary ammonium compound.

6. A fabric conditioner composition as claimed in claim 1, wherein anion quencher is said mono-long chain quaternary ammonium compound.

7. A fabric conditioner composition as claimed in claim 1, comprising 0.01-3% by weight an antifoam agent.

8. A fabric conditioner composition as claimed in claim 1, wherein said organic acid has from 2 to 6 carbon atoms.

9. A fabric conditioner composition as claimed in claim 1, wherein said organic acid is citric acid.

10. A fabric conditioner composition as claimed in claim 1, wherein said antifoam agent is silicone based.
